(19) United States
(12) Patent Application Publication
(10) Pub. No.: US 2025/0205784 A1
(43) Pub. Date: Jun. 26, 2025

(54) Real Time Control Of Laser Additive Manufacturing With High Speed Optically Calibrated On Axis Sensing

(71) Applicant: The Johns Hopkins University, Baltimore, MD (US)

(72) Inventors: Brendan P. Croom, Baltimore, MD (US); Morgana M. Trexler, Baltimore, MD (US); Ari M. Lax, Silver Spring, MD (US); Michael S. Brown, Silver Spring, MD (US); Vincent R. Pagan, Ellicott City, MD (US); Mary E. Daffron, Columbia, MD (US); Steven M. Storck, Catonsville, MD (US)

(73) Assignee: The Johns Hopkins University, Baltimore, MD (US)

(21) Appl. No.: 18/922,714

(22) Filed: Oct. 22, 2024

Related U.S. Application Data
(60) Provisional application No. 63/613,787, filed on Dec. 22, 2023.

(51) Int. Cl. B22F 10/368; B22F 10/28; B22F 12/44; B22F 12/90; B23K 26/342; B33Y 10/00; B33Y 30/00; B33Y 50/02

(52) U.S. Cl. CPC B22F 10/368; B22F 10/28; B22F 12/44; B22F 12/90; B23K 26/342; B33Y 10/00; B33Y 30/00; B33Y 50/02

(57) ABSTRACT

A system for controlling an additive manufacturing processing may include an energy source operable to emit a beam to heat a powder bed to form a melt pool, a detection system disposed for on axis sensing of a temperature profile of the melt pool where the detection system includes a plurality of independently filtered channels that each monitor a spectral response of the melt pool to determine the temperature profile based on the spectral response of the plurality of independently filtered channels, and a control system comprising a high speed FPGA or ASIC operably coupled to the detection system to receive the temperature profile and define a control response for controlling operation of the energy source.

### CROSS-REFERENCE TO RELATED APPLICATIONS

This application claims priority to and the benefit of prior-filed, co-pending U.S. Provisional Application No. 63/613,787 filed on Dec. 22, 20243 the entire content of which is hereby incorporated herein by reference.

### STATEMENT OF FEDERALLY SPONSORED RESEARCH OR DEVELOPMENT

This invention was made with Government support under contract number N0014-22-1-2687 awarded by the Office of Naval Research (ONR). The Government has certain rights in the invention.

### TECHNICAL FIELD

Example embodiments generally relate to additive manufacturing and, in particular, to laser control and sensing systems employed in conjunction with additive manufacturing.

### BACKGROUND

Additive manufacturing, which can be considered a type of three-dimensional (3D) printing, is useful in a wide variety of applications for constructing new and replacement parts. In many instances, additive manufacturing techniques are superior to many conventional manufacturing techniques due to the ability to construct shapes of parts that could not be constructed using conventional techniques. Additive manufacturing is often used in the construction of component parts for large complex devices, such as vehicles. For example, in the aviation industry, additive manufacturing techniques have proven to be very useful for manufacturing aviation components. Because high stresses and strains may be placed on aviation components, parts must be certified for use in the construction of the aircraft, and therefore it is often important to minimize defects in a part that can be formed when using additive manufacturing techniques.

Defect formation during the manufacturing of a part can occur for a number of reasons. For example, melt temperatures that are too high or too low can lead to defects. While a singular defect is often of little concern, a collection of defects or defects located at certain critical locations can increase the likelihood that a part may fail when in use. As a result, parts must often be subjected to post-production scanning using, for example, x-ray technologies. These scanning processes capture internal images of the part that are reviewed to identify defects that may be problematic and require the part to be scrapped, often after many hours of manufacturing and inspection time. The inspection process alone can be quite time consuming, often accounting for fifty to sixty percent of the total cost of the production of the part. As such, it would be beneficial to limit or avoid the additional time and cost associated with post-production scanning and defect detection. Moreover, it would be beneficial to provide real time feedback capability for control of the laser during the process of forming each layer so that in-layer healing may be conducted with respect to any detected defects.

### BRIEF SUMMARY

According to some example embodiments, a system for controlling an additive manufacturing processing may be provided. The system may include an energy source such as a laser operable to emit a beam to heat a powder bed to form a melt pool, a detection system disposed for on axis sensing of a temperature profile of the melt pool where the detection system includes a plurality of independently filtered channels that each monitor a spectral response of the melt pool to determine the temperature profile based on the spectral response of the plurality of independently filtered channels, and a control system including a controller such as a high speed field programmable gate array (FPGA) or ASIC operably coupled to the detection system to receive the temperature profile and define a control response for controlling operation of the laser.

According to some example embodiments, a method for controlling an additive manufacturing process may be provided. The method may include heating, via an energy source, a melt zone to fuse an additive media with an active layer to build a part being manufactured based on a part design model. The method also includes capturing, by a detection system disposed for on axis sensing of a temperature profile of the melt zone, raw melt data of the melt zone. The detection system includes a plurality of independently filtered channels that each monitor a spectral response of the melt zone to determine the temperature profile based on the spectral response of the plurality of independently filtered channels. The method also includes employing a control system including a controller such as a high speed field programmable gate array (FPGA) or ASIC operably coupled to the detection system to receive the temperature profile to define a control response for controlling operation of the energy source in real-time.

### BRIEF DESCRIPTION OF THE DRAWINGS

Having thus described some example embodiments in general terms, reference will now be made to the accompanying drawings, which are not necessarily drawn to scale, and wherein:

FIG. 1 illustrates an example laser generation assembly for an additive manufacturing system constructing a part according to an example embodiment;

FIG. 2 illustrates an example sensor for use in an additive manufacturing and monitoring system according to an example embodiment;

FIG. 3 illustrates an example additive manufacturing and monitoring system configured for in situ defect analysis and healing according to an example embodiment;

FIG. 4 illustrates a block diagram of a detection system for use in an additive manufacturing and monitoring system according to an example embodiment;

FIG. 5 illustrates a series of plots demonstrating calibration to allow decoupling of non-linear behavior of commercial galvanometers and lenses according to an example embodiment;

FIG. 6 illustrates a process for in situ defect analysis and defect detection in accordance with an example embodiment;

FIG. 7 illustrates a flowchart of a process for generating, via machine learning, a defect signature library according to an example embodiment;

FIG. 8 illustrates an example additive manufacturing and monitoring apparatus configured for in situ defect analysis according to an example embodiment; and

FIG. 9 illustrates flowchart of an example manufacturing and monitoring method for in situ defect analysis according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

According to various example embodiments, systems, apparatuses, and methods are described herein that enable in situ detection of defects during the additive manufacturing process, and further enable healing of defects detected via a healing pass. To do so, imaging data of a plurality of (e.g., two or more, and in some cases four or more) independently filtered channels may be captured by one or more sensors (e.g., photodiodes, cameras, or the like) directed at a melt zone generated by a laser or other energy source. Although not required, in some cases, the plurality of independently filtered channels may include at least one in the infrared band and at least one in the visible light band. The sensor may capture, for example, light intensity data, spectral data, or the like at the melt zone, which may be converted, for example, into thermal data indicative of the temperature at the melt zone coupled with spatial or position data for where that temperature was measured. The thermal information may be compared to predefined or trained defect signatures to determine whether a defect has occurred during the manufacturing process. The defect signatures may be trained via machine learning. Moreover, example embodiments may further enable the laser control to be performed in such a way that real-time control and in-layer healing can be performed. To accomplish this, response times for the control system must be dramatically reduced to less than about 1 to 10 microseconds. Calibration may also be performed to correct for optical phenomenon affecting the detected signal at the measured wavelengths or, in some cases, correcting for non-linear optics and aspects of optical limitations such as chromatic aberration and thin film interference.

Because defects may be detected during manufacturing, the manufacturing process would previously typically be immediately stopped upon detection of a problematic defect, and the partially completed part may be scrapped, rather than spending the unnecessary time completing a defective part. Alternatively, as noted above, manufacture-time remedial measures may be taken to, for example, heal a detected defect during the manufacturing process. Also, because defect detection is performed during manufacturing, post-production scanning can be eliminated from the part production process, and parts can be certified as soon as manufacturing is complete. Such an approach therefore leads to substantial reductions in the time and cost of part production using additive manufacturing processes.

As such, tomography may be performed based on, for example, thermal data and other data as the part is being manufactured and the defects can be identified within the tomography. In some instances, remedial measures need not be taken to eliminate the defect, but the location of the defect may be logged within a three-dimensional defect model that is continually generated as the part is being manufactured. As such, when the manufacturing process is complete, an entire model of the part, with identified defects, is also generated and may be, when necessary, immediately considered in a post-production analysis for part certification. Even when such post-production analysis takes place, the cost and time associated with x-ray scanning the part may be avoided or reduced. Such an approach may be particularly useful in additive manufacturing where the material being used for the manufacturing cannot be penetrated by x-ray imaging or x-ray imaging can only penetrate with a high enough energy to resolve large defects (e.g., 1 millimeter dimension defects when sub 0.1 millimeter dimension defect detection is needed), but certification of the part must still be performed.

According to some example embodiments, the in situ tomography and defect detection as described herein may be implemented, for example, in the context of additive manufacturing techniques such as powder bed fusion techniques using a laser, electron-beam, or the like. More specifically, according to some example embodiments, additive manufacturing techniques such as directed energy disposition or selective laser melting (SLM), also called laser powder bed fusion (LPBF). SLM is a type of metal additive manufacturing technique that uses a laser or other energy source to melt or fuse a metal powder onto a substrate to build a metal part in a layered process. In this regard, according to some example embodiments, a 3D model of a part may be designed and stored as a design model. The 3D design model may then be decomposed into a number of two-dimensional (2D) layers. The 2D layers actually have a thickness of, for example, 20 to 100 micrometers, although both larger and smaller thicknesses are possible in some cases. The SLM system may construct the part by forming each of the 2D layers in a process where the layer is constructed on a next layer, one layer at a time.

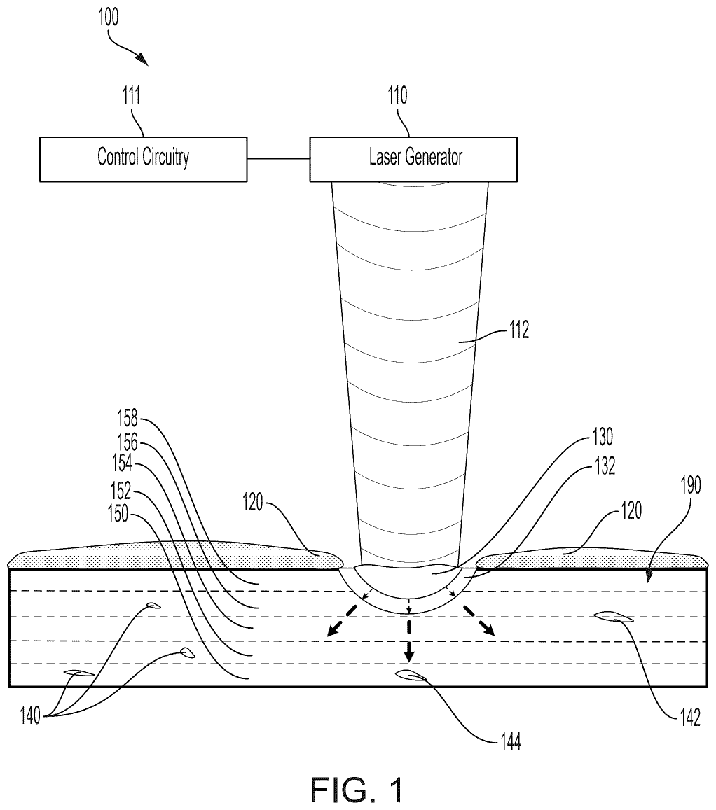

Referring now to FIG. 1, an example system 100 for performing additive manufacturing using as laser 112, such as an SLM system, is shown. A laser generator 110 may be generate the laser 112 under the control of the control circuitry 111. The laser generator 110 may be a high-powered (e.g., 200 watt or more) laser generator that is configured to move or scan across the surface of a part 190 to control the melting of a powder 120 (e.g., a metal powder) to build the part 190. The control circuitry 111 may be configured to control the laser generator 110 based on a 3D design model of the part 190 or 2D layers of the 3D part model to construct the part 190. According to some example embodiments, the laser generator 110 may be a generator of another type of energy source device such as an electron beam generator, a microwave beam generator, or the like.

As shown in FIG. 1, the laser 112 has already formed layers 150, 152, 154, and 156 of the part 190, and the laser 112 is currently melting the powder 120 to form layer 158. As such, layer 158 may be referred to as the current, processing or active layer, while the previous layers may be previously constructed, sintered layers. The laser 112 may melt the powder 120 in a melt zone into a melt pool 130 of molten material to form the layer 158. However, the melt pool 130 may extend into lower layers as shown in FIG. 1, where the melt pool extends into layer 156 to re-melt portions of the layer 156. As such, due to heat conduction from the laser 112 and the melt pool 130, a re-melt region 132 may form with the heat conduction in the re-melt region being indicated by the arrows. Heat may also be conducted into the areas surrounding the re-melt region 132. While these areas may not become molten, the conduction of heat may still affect the molecules and cause changes in the microstructures of the surrounding layers of the part 190.

The powder 120 may be an example embodiment of an additive media used in the additive manufacturing process. The powder 120 may be formed of an atomized metal that fuses with the previously formed layers. A variety of metals may be used in such an additive manufacturing process. For example, the powdered metal may be copper, aluminum, stainless steel, titanium, tungsten, nickel-based super alloys, or the like. The powder 120 may be applied to the surface of the part 190 such that the powder 120 melts and flows into the melt pool 130. According to some example embodiments, the part 190 and the powder 120 may be formed of a material that does not permit x-ray imaging due to scattering, such as, for example, platinum, gold, lead, or the like.

The control circuitry 111 may control the laser generator 110 and the manufacturing process for the part 190. In this regard, the control circuitry 111 may load, for example, each of the 2D layers of the design model of the part 190 and then control the laser generator 110 to construct the part 190, layer-by-layer. In this regard, the control circuitry 111 may control the direction of the laser 112, as well as other characteristics, such as the intensity of the laser 112. According to some example embodiments, the laser 112 may be steerable, the laser generator 110 may be moveable, or a support surface of the part 190 may be moveable under the control of the control circuitry 111 during manufacturing to change the relative position of the part 190 and the laser 112.

According to some example embodiments, the control circuitry 111 may include a processor, which may take the form of a controller. The processor may be operably coupled with a memory to store instructions for execution by the processor. As such, the processor may be software-configured to control, for example, the laser generator 110 to perform a part build or construction process. Alternatively or additionally, the processor may be embodied as a hardware-configured processor in the form of a field programmable logic array (FPGA), an application-specific integrated circuit (ASIC), or the like. The processor may include communications capabilities, either directly or via a communications interface component. As such, the processor may configured to communicate via wired or wireless communications to, for example, receive a 3D design model for conversion to 2D layers to perform a build of the part 190.

As mentioned above, during the process of manufacturing the part 190, defects may be introduced into the resulting structure of the part 190. Because the environment and the thermal aspects of the manufacturing process cannot be perfectly controlled and maintained at all times, fluctuations in the temperature of the melt pool 130 may occur that can lead to the formation of defects. For example, if the temperature is too low, a lack of complete fusion can occur resulting in a defect. Alternatively, if the temperature is too high, a keyhole-type defect may be formed. Accordingly, the part 190 in FIG. 1 is shown with defects 140, 142, and 144, which may be lack of fusion defects, re-coating driven defects or keyhole defects. As shown, the defects 140 are single-layer defects. However, the defect 142 may be a multi-layer defect that spans between layer 154 and layer 156.

Additionally, defect 144 may be a single-layer defect in layer 150. However, defect 144 may be disposed close enough to the melt pool 130 that a portion of the conducted heat from the melt pool 130 may be received by the layer 150 and the defect 144. As such, in some instances, sufficient heat may be received at the defect 144 to change the microstructure and “heal” the defect. Therefore, even though construction of layer 150 occurred previously, the structure of layer 150 may still be altered by the conduction of heat. While such healing may occur simply due to the proximity of the defect to the melt pool 130, in some example embodiments, the control circuitry 111 may control the laser generator 110 to cause the conduction of heat in a manner that causes the healing of a known defect.

Notably, the laser generator 110 is exemplary of an energy source, which may include one or multiple lasers. Moreover, the laser 112 is merely exemplary of one type of energy emission that may be used in example embodiments. Thus, for example, the laser 112 could be replaced by an e-beam, IR light beam, directed microwave, or any of a number of other beams that can generate thermal energy when directed to the melt pool 130.

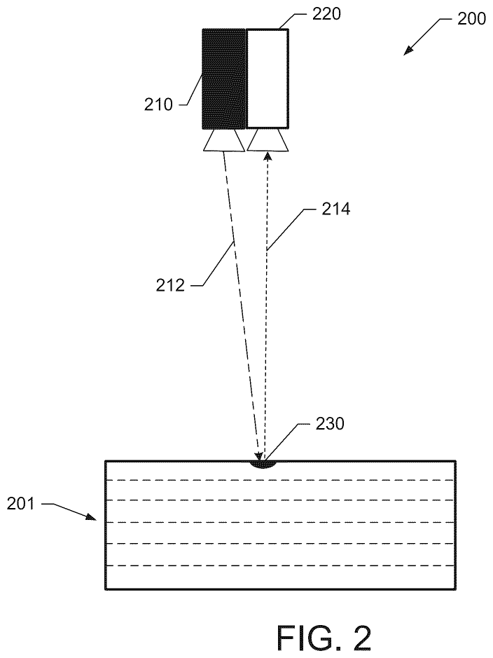

Having described aspects of the additive manufacturing process, and the ability to heal previously formed defects, it should be appreciated that with sufficiently accurate ability to sense or detect defects during the formation of the active or current layer, the potential might also exist to make efforts to heal the defect before proceeding to a subsequent layer. Thus, for example, highly accurate and yet extremely fast identification of defects may be needed so that a control response may be directed to cause the laser generator 110 to heal the defect. Such accurate sensing may be accomplished via a detection system that uses spectral analysis regarding reflected light from the melt pool 130. FIG. 2 is a block diagram of a detection system 200 that may include additional sensors and/or components associated with practicing example embodiments to permit real-time control of laser additive manufacturing with high-speed optically calibrated on axis sensing.

In this regard, the detection system 200 of FIG. 2 will now be described to explain how additive manufacturing that includes monitoring sensors may facilitate real-time laser control as mentioned above. In this regard, the detection system 200 may include some components similar to, or used in, the system 100 of FIG. 1. However, the detection system 200 is further aimed at describing the use of one or more sensors configured to capture data relating to the manufacturing process. The detection system 200 may include a laser generator 210 that is similar to the laser generator 110 for constructing a part 201 in a number of layers. However, the laser generator 210 may include or be coupled to a melt pool sensor 220. The melt pool sensor 220 may be one sensor of a multi-sensor or disperse sensor suite, which may be employed in some embodiments. The disperse sensor suite may include, for example, an acoustic sensor with thermal sensing capabilities for one or more (and in some cases, four or more) color spectral sensing. Although not shown, the laser generator 210 may be controlled by the control circuitry, which may be similar the control circuitry 111 of FIG. 1.

The laser generator 210 may be configured to output a laser 212 to form the melt pool 230 similar to the laser generator 110 of FIG. 1. However, radiation in the form of, for example, visible and/or infrared light may be reflected by the melt pool 230, as the reflection 214, and may be received by the melt pool sensor 220. The melt pool sensor 220, according to some example embodiments, may be photodiode configured to measure spectral characteristics of the light received at the sensor (e.g., wavelength of the reflected light), an intensity of light received by the sensor within a spectral band, and/or the like. Although, the reflection 214 appears to be received a different angle from the laser 212, according to some example embodiments, the positioning of the melt pool sensor 220 may be such that the reflection 214 travels the same path as the laser 212, and is therefore on-axis with respect to the laser 212. The spectral characteristics or light intensity may be measured and provided to the control circuitry for storage or real time analysis as raw melt data of the melt zone, which includes the area of the melt pool 230. The raw melt data may be coupled with spatial information indicating the position on the part 201 where the raw melt data was captured. Additionally, the spectral characteristics of the light or the intensity of the visible light received by the melt pool sensor 220 may be indicative of the temperature at the surface of the melt pool, which may be determined via a conversion by the control circuitry.

According to some example embodiments, the detection system 200 may include a variety of other sensors that may be employed to capture additional raw melt data for use in analysis. In this regard, additional types of sensors and sensors with the same or differing viewpoints may be included. Thus, for example, different sensors may be used to capture different bands of visible, infrared or other measurable light with the same or different viewpoints. According to some example embodiments, any sensor configured to capture reflected radiant energy from the melt zone may be employed, where the sensors are tuned to capture data associated with reflected energy within a desired range of the electromagnetic spectrum. In this regard, according to some example embodiments, the sensors, including the melt pool sensor 220, and any other included sensors, may include photodiodes, photomultiplier tubes, cameras, or the like.

Additionally, because the raw melt data is spatially correlated, data from different sensors can be combined. Regardless of the number and type of sensors, the raw melt data collected by the sensors may be provided to the control circuitry 111 and combined into a dataset for the part 201. In this regard, according to some example embodiments, the raw melt data may be captured in association with position and timing data. The raw melt data, in the form of spectral data (e.g., wavelength of the reflected light), may therefore be coupled with spatial information in the form of a position indicating where the spectral data was captured. Additionally, a time stamp for the raw melt data may be coupled with the spectral data. The raw melt data may then be converted, for example, into temperature or thermal data or the conversion may wait until processing of the data is necessary. In either case, the raw melt data or the converted data may be stored. According to some example embodiments, the sensors may be configured to capture the raw melt data at a sampling rate based on the ability of the system to process the raw melt data. In some instances, the analysis of the raw melt data may be slow relative to the available sampling rate of the sensors. As such, according to some example embodiments, light intensity data may also be captured and utilized in the same or similar manner as the spectral data. However, with respect to the light intensity data, according to some example embodiments, only a peak light intensity may be captured and stored over a set duration of time.

The structure of the sensor data (either raw melt data or converted raw melt data) may be organized in a number of ways. According to some example embodiments, the raw melt data may captured and handled on a layer-by-layer basis. As such, data for a particular layer may be coupled with a layer identifier or the layer may be determined from the position data associated with the raw melt data. Accordingly, raw melt data for the active layer (layer currently under construction) may be populated into an active layer dataset for that layer. Subsequent layers may therefore have associated layer datasets. Accordingly, the raw melt data for the layers that have been constructed may be stored in a data structure including the active layer dataset (for the layer currently being constructed) and data for the previously constructed layers. Regardless of how the data is structured or organized, the raw melt data including at least the active layer dataset may be provided for data analysis to determine if a defect has occurred.

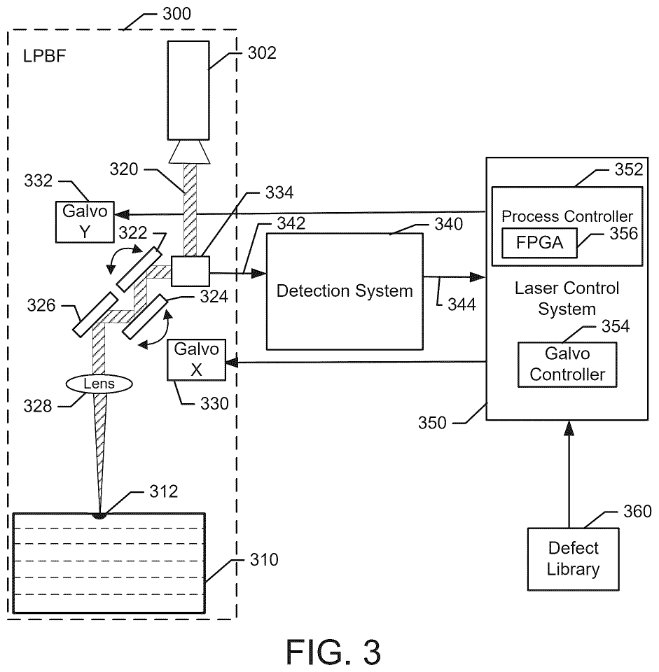

Combination of the detection system 200 with the system 100 may further be enhanced with real-time capable laser control to permit adaptive healing with respect to a current layer. FIG. 3 illustrates a combined system for real-time control of laser additive manufacturing in accordance with an example embodiment. In this regard, FIG. 3 illustrates a laser power bed fusion (LPBF) tool 300 that includes a laser 302 that may be similar to the example laser generators 110 and 210 of FIGS. 1 and 2. The LPBF tool 300 may operate on a part 310 that may be multi-layer similar to part 201 of FIG. 2, and may have a melt pool 312 formed at the current or active layer. The laser 302 may generate a beam 320 that is steered and/or focused via, for example, a series of mirrors and/or lenses. In the depicted example, a first mirror 322, a second mirror 324, a third mirror 326, and a lens 328 may be used to direct the beam 320 toward the melt pool 312. The lens 328 may, for example, be an F-theta lens, or any other suitable lens for focusing the beam 320. In some cases, one or more galvanometers (e.g., galvo X 330 and galvo Y 332) may be provided to control x and y coordinate positioning of the mirrors and/or lenses of the LPBF tool 300 and, as will be discussed in greater detail below, the galvanometers may be controlled actively in an effort to minimize (or heal) defects via real-time laser control.

Reflections from the melt pool 312 may travel back along the same path as the beam 320 into a directive component such as a beam splitter 334. The beam splitter 334 may, for example, be a dichroic beam splitter, which may direct the beam 320 to the mirrors and lens (or lenses) in one directly, and direct reflections toward a detection system 340, which may be similar to, or a more detailed example of the detection system 200 of FIG. 2. The reflections may be passed from the LPBF tool 300 to the detection system 340 via a fiber optic cable 342 to minimize delay in transmission.

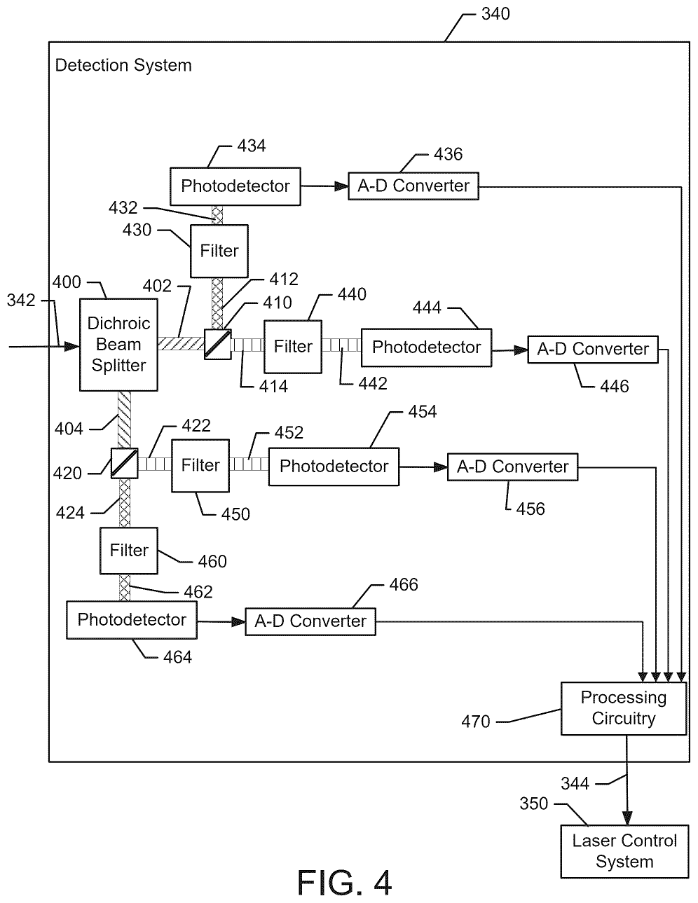

Specific details of the detection system 340 will be described in greater detail below in reference to FIG. 4. However, an output 344 of the detection system 340 may be provided to a laser control system 350, which may be configured to minimize any response time needed to generate a control response that provides the real time control of the laser 302 mentioned above. The laser control system 350 may include a process controller 352 (e.g., a PID controller) to determine the nature of the control response, and a galvo controller 354, which interfaces with the galvanometers (e.g., galvo X and galvo Y) based on the control response defined by the process controller 352. In an example embodiment, the process controller 352 may interface with a defect library 360 that includes a priori information of defects and also, in some cases, healing strategies for dealing with defects, in order to enable the process controller 352 to evaluate the output 344 of the detection system 340 and determine the control response for providing real time control over operation of the laser 302.

Turning now to FIG. 4, the fiber optic cable 342 may provide the reflections to a dichroic beam splitter 400 at an input stage of the detection system 340. Of note, the dichroic beam splitter 400 is merely an example of an intermediate beam splitter more generally, and need not necessarily be dichroic. In some cases, a collimator may be provided at a termination of the fiber optic cable 342 and before the dichroic beam splitter 400. The output of the dichroic beam splitter 400 may include a first intermediate beam 402 and a second intermediate beam 404. The first intermediate beam 402 may then be provided to a first optical beam splitter 410, which may split the first intermediate beam 402 into a first beam 412 and a second beam 414. The second intermediate beam 404 may be provided to a second optical beam splitter 420, which may split the second intermediate beam 404 into a third beam 422 and a fourth beam 424. In some cases, the first and second optical beam splitters 410 and 420 may be embodied as dichroic beam splitters.

The detection system 340 may further include a first optical bandpass filter 430 to filter the first beam 412 prior to digitization of the filtered first beam into a first filtered channel 432. Digitization may be performed via a first photodetector 434 and a first analog-to-digital converter 436. The detection system 340 may also include a second optical bandpass filter 440 to filter the second beam 414 prior to digitization of the filtered second beam into a second filtered channel 442 by a second photodetector 444 and a second analog-to-digital converter 446. The detection system 340 may also include a third optical bandpass filter 450 to filter the third beam 422 prior to digitization of the filtered third beam into a third filtered channel 452 by a third photodetector 454 and third analog-to-digital converter 456. The detection system 340 may also include a fourth optical bandpass filter 460 to filter the fourth beam 424 prior to digitization of the filtered fourth beam into a fourth filtered channel 462 by a fourth photodetector 464 and fourth analog-to-digital converter 466 of at least four independently filtered channels (e.g., the first, second, third, and fourth filtered channels 432, 442, 452 and 462). After digitization of the four independently filtered channels, processing circuitry 470 may receive and, in some cases, process the output 344 of the detection system 340 for provision to the laser control system 350. In an example embodiment, the processing circuitry 470 may be embodied as an 8 channel analog-to-digital converter (ADC), which may be operably coupled to a high speed FPGA 356 of the process controller 352. The galvo controller 354 may then employ, for example, a 16 channel digital-to-analog converter (DAC) for communication with the LPBF tool 300 (e.g., to control galvo X 330 and galvo Y 332).

The provision of the detection system 340 in the form shown in FIG. 4 may provide improved in situ monitoring for use with the LPBF tool 300. Moreover, the use of four independently filtered channels may provide a multi-spectral (i.e., greater than or equal to four channels), high speed (greater than 500 kS/s), high resolution (less than 100 micrometers), on-axis, fiber coupled monitoring solution that enables real-time laser control of the LPBF tool 300. In some cases, the sensor assembly of the detection system 340 may be referred to as a spectrally augmented thermal understanding reducing nonconformance (SATURN) sensor. The SATURN sensor allows the high rate of volumetric scanning and cooling, which otherwise creates challenges in capturing peak temperatures, to be managed by enabling a high capacity for processing large chunks of data at high data rates. This enables rapid processing, which can also enable rapid control of the LPBF tool 300 in real-time, without introduction of large sources of error in relation to capturing true real-time temperature data.

The process controller 352 may employ vision-based machine learning to detect the structure and morphology of defects within layers of the part 310. In this regard, for example, the in situ monitoring of the detection system 340 provides image data indicative of temperature based on thermal emission at the melt pool 312. The vision-based machine learning employed by the process controller 352, using information stored in the defect library 360, therefore allows rapid detection of defects so that, for example, a healing pass may be directed by the process controller 352 (e.g., via adjusting galvo X 330 and galvo Y 332 through the galvo controller 354) for an active layer prior to proceeding to a subsequent layer. Moreover, although the healing pass may be provided specifically by the laser 302, in some cases, a second laser may be used to perform the healing pass.

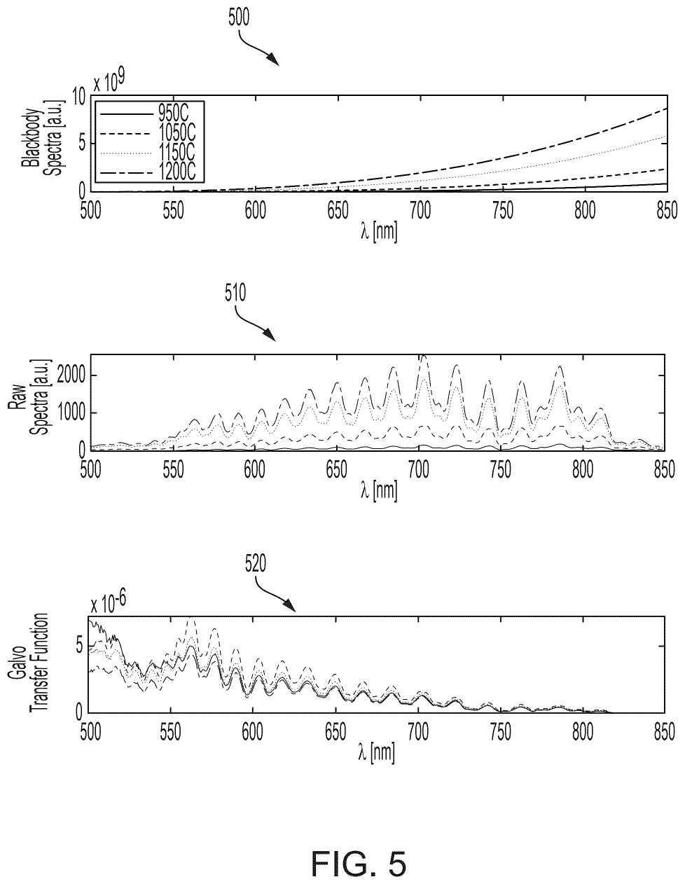

In an example embodiment, the process controller 352 may also be configured to perform calibration operations with respect to the optical information received. In this regard, for example, the process controller 352 may be configured to perform a correction for highly non-linear optics in order to enable an accurate optical response. The process controller 352 may therefore be configured to consider a theoretical response with respect to any measured response, and apply a calibration transfer function thereto in order to calibrate the spectral response of galvo optics. FIG. 5 illustrates an example plot 500 of wavelength versus blackbody spectra, which defines the theoretical response, an example plot 510 of wavelength versus raw spectra, which defines the measured response, and an example plot 520 of wavelength versus galvo transfer function, which provides the calibration transfer function. As can be appreciated from FIG. 5, calibration may be conducted for the optical components of the detection system 340 via the application of the calibration transfer function while avoiding a slowdown in the processing of the process controller 352. Accurate optical information may therefore be used for the calculations that follow without introducing additional latency.

As noted above, one of the enabling qualities for real-time monitoring and laser control is low latency. In particular, a latency of lower than 1 to 10 microseconds represents an order of magnitude improvement over lag times that conventionally exists. With low latency, the ability to provide active laser control via feedforward or feedback control becomes achievable, and the identification of defects in real-time, along with the healing of those identified defects, becomes possible.

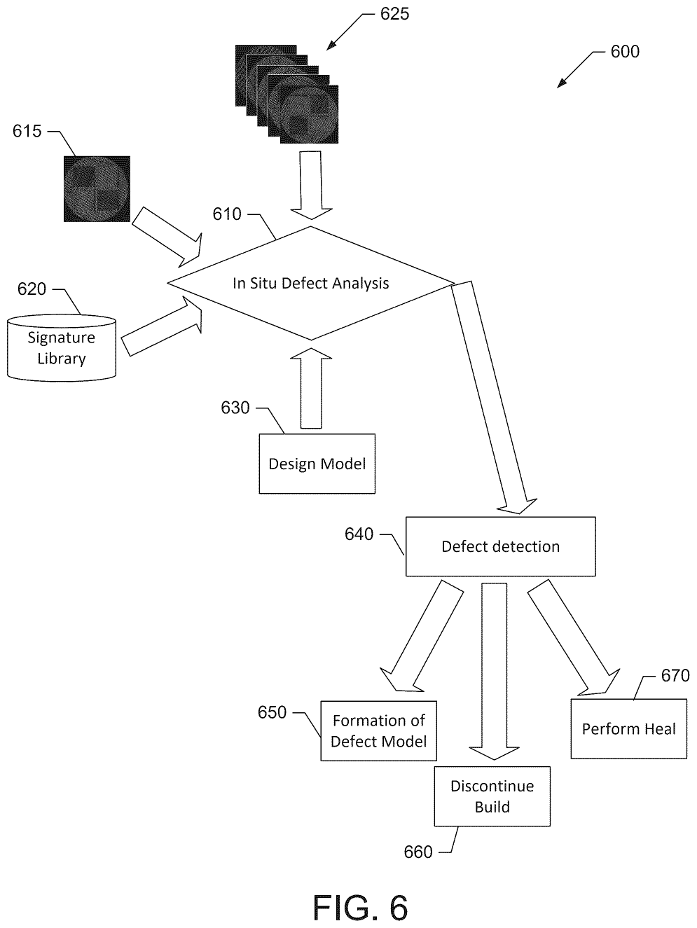

FIG. 6 will now be described, which illustrates a process for performing in situ defect analysis for defect detection and defect model formation during part manufacturing. According to some example embodiments, the process 600 may be performed by the process controller 352. In this regard, an active layer dataset 615 is shown as an input to the in situ defect analysis 610. The active layer dataset 615 may be a partial or complete dataset for the current layer being constructed. According to some example embodiments, the active layer dataset 615 may be compared to a database of defect signatures stored in the signature library 620 (e.g., from defect library 360 of FIG. 3). The defect signatures within the signature library 620 may be templates that can be used in comparison to determine if a defect has occurred.

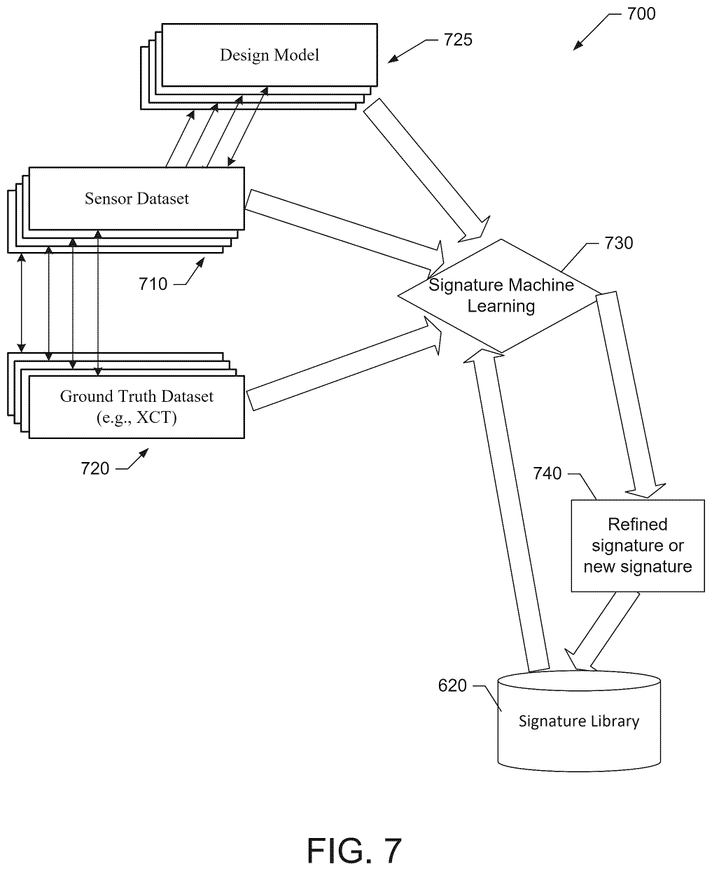

In this regard, for example, with respect to thermal data, it has been determined that the spectral characteristics and intensity of light reflected by the laser 302 incident upon the part 310 during construction can provide indications of when a defect is being formed. Such indications may be substantially nuanced and therefore the use of machine learning is helpful for determining and refining the signatures to form the signature library 620. As described herein, the machine learning may be based on thermal data, but, according to some example embodiments, spectral data from individual spectral channels may also be used in the machine learning. Departing from the in situ defect analysis of FIG. 6 momentarily, the development and refinement of the signature library 620 will first be described with respect to FIG. 7.

In this regard, referring to FIG. 7, a process 700 for developing and refining the signature library 620 is shown. The process 700 may be a training process for developing the signature library 620. It is understood that the process 700 of FIG. 7 is merely exemplary of a machine learning process that could be used for developing the signature library 720, but is not the only machine learning approach that may be used. Additionally, while the library is referred to as a “signature” library, it is understood that the signatures may be embodied as machine-learned features or collections of machine-learned features. Certainly, different and more complex machine learning techniques may be employed. For example, according to some example embodiments, down-selecting of the raw melt data or additional computations on the raw melt data may be performed, for example, to determine an optimized set of inputs for defect detection. As an input to the process 700, a number of part builds have been previously performed and sensor data (e.g., raw melt data) associated with each build has been stored in a collection of part-build sensor datasets 710. These part-build sensor datasets 710 may include raw melt data or may include versions of the raw melt data that have been processed for machine learning. For purposes of explanation, the sensor data may be spatially defined thermal data, but it is understood that other types of data may be combined with or used in lieu of thermal data. For each part build, a post-processing scan of the resultant part has been performed using, for example, an x-ray computed tomography (XCT) approach to generate a ground truth dataset for each part. As such, a collection of ground truth datasets 720 may be generated. Accordingly, for each part build, a sensor dataset from the collection 710 and an associated ground truth dataset from the collection 720 may be utilized with the arrows between the collections indicating that certain datasets are linked via to a common part build.

The collections 710 and 720 may be provided for signature machine learning at 730 for processing and signature training. The ground truth datasets may be analyzed to determine the existence and locations of defects within a respective part. With the defects identified and located based on the ground truth dataset, the machine learning process at 730 may continue by analyzing the associated sensor dataset. In this regard, a specific defect identified from the ground truth dataset may be used to identify data within the sensor dataset that has any relationship with the defect (e.g., based on position). Accordingly, the beginnings of a signature for the defect in terms of thermal data may be generated at 740 and the new signature may be stored in the signature library 620. Depending on the data that is still available for signature machine learning 730, further refinement or new signature definition may be performed.

If further data for signature machine learning is available, then a process of determining new signatures or refining existing signatures may also be performed at signature machine learning 730. In this regard, a new defect may be selected for analysis that was identified from the ground truth dataset. Again, data within the sensor dataset that has any relationship with the defect (e.g., based on position) may be considered for inclusion in a signature. Signatures from the signature library 620 may be pulled into the signature machine learning at 730 for comparison with the selected sensor data. The selected data from the sensor dataset may first be compared to existing signatures to determine if the selected data is an example instance of an already defined signature or a new signature based on a threshold number of similarity characteristics being found between the sensor data and an existing signature. In other words, if the selected data is sufficiently similar to an existing signature, then the existing signature may be subjected to a refinement process. In this regard, the selected data may be compared with the data of the existing signature to refine the signature by, for example, reducing non-defect indicating variables from the signature based on the selected data from the sensor dataset. In this manner, the signatures of the signature library 620 may be continually refined and simplified via machine learning and consideration of new data to improve accuracy for identifying defects when employed in an in situ analysis and to improve the speed of identifying defects when employed in an in situ analysis.

Alternatively, if a threshold number of similarity characteristics is not found (i.e., the selected data is not sufficiently similar to an existing signature), then a new signature may be defined based on the selected data at 740 and the new signature may be stored in the signature library 620. According to some example embodiments, divergence of the signature dataset should occur within the signature library 620 thereby creating discrete signatures for identifying defects. However, in some instances, it can occur that parallel signatures may develop that are related, but were initially derived on a different basis. As such, according to some example embodiments, a comparison of the signatures themselves may be performed to determine if parallel signatures have been formed (e.g., identified by having a threshold number of similar characteristics) and an analysis of the similar signatures may be undertaken to determine if the two parallel signatures may be simplified into a single signature. Additionally, according to some example embodiments, in the event that ground truth datasets are formed, for whatever reason, those datasets may be used with associated sensor data to continually improve the signature library 620.

As described above, the signatures of the signature library 620 may be determined based on sensor data of a single layer of a build or sensor data from multiple layers of a part build. In this regard, the sensor data that is selected for analysis with respect to a defect may be selected from a number of layers of the part that is associated with the sensor data. As such, the determination of a signature may be based on the final layer that was affected by the defect and prior layers. In other words, the determination of a defect need not be a singular layer analysis and may involve the analysis of sensor data from a number of layers.

Additionally, a defect signature may also be based on the architecture of the part. In this regard, the temperature responses may be different depending on the architecture of the feature being constructed at that time. In other words, different features may have different radiation responses and therefore a signature may account for the effects of the part's architecture. As such, in addition to the sensor data collection 710 and the ground truth dataset 720, the associated design model of the part being constructed may be factored into the signature machine learning 730. Accordingly, a collection of design models 725 may also be used as an input, where each of the design models corresponds to a part that has a counterpart sensor dataset and ground truth dataset (as indicated by the arrows with the sensor dataset). In this regard, the sensor dataset, the ground truth dataset, and the design model may be correlated based on a common spatial coordinate system so that data relevant to a defect can be extracted and refined into a defect signature for use in detecting similar defect signatures. Accordingly, the signature library 620 may be generated for use in manufacture-time assessment of system operation to detect defects in a part being manufactured.

Having described the development of the signature library 620 using a signature machine learning approach, the description will now turn back to FIG. 3 and the application of the signature library 620 in the context of in situ defect analysis and defect detection. As previously described, the active layer dataset 615 may be compared to signatures within the signature library 620 as an operation of the in situ defect analysis 610 to perform defect detection at 640. Such comparisons may be performed at high processing speeds and therefore resolution of a defect may be performed while the part is being constructed. According to some example embodiments, a variety of comparison techniques may be employed. For example, a nearest neighbor search technique or other similarity assessment may be performed as part of the in situ defect analysis 610. Further, according to some example embodiments, machine-learning algorithms may be employed as part of the in situ defect analysis 610. For example, when using machine-learning algorithms, the in situ defect analysis 610 may involve the signature library 620, formed as a machine learning model, having the comparison operations embedded in the signature library such that the inputs to the in situ defect analysis 610 can be applied to the signature library 620 and the library may be configured to output defect detections.

Further, with respect to the comparisons that are performed for defect detection, according to some example embodiments, a similarity threshold may be applied to the comparison between the active layer dataset 615 and the defect signatures within the signature library 620 to determine if the active layer dataset 615 includes sufficient similarities to determine that a match with a defect signature within the signature library 620 has been identified. If a match is found, a defect may be detected at defect detection 640 while the manufacturing process is being conducted.

According to some example embodiments, the active layer dataset 615 may be one example input that is considered in the in situ defect analysis 610 to detect a defect at 640. However, according to some example embodiments, a number of other factors may be considered and coupled with the active layer dataset 615 for comparison with the defect signatures of the signature library 620 to identify a defect. In this regard, for example, prior layer datasets 625 associated with the manufacturing of prior, lower layers of the part may be included as an input to the in situ defect analysis 610. As mentioned above, the defect signatures may be based on data associated with multiple layers of a build, and therefore the prior layer datasets 625, with the active layer dataset 615, may be compared to the signature library 620 to identify a defect signature that may match the combined layer data to indicate that a defect has been identified.

Additionally, according to some example embodiments, the design model 630 of the part under construction may also be an input into the in situ defect analysis 610. In this regard, the design model 630 may be a 3D digital model of the part or a collection of 2D layers that make up the 3D digital model. Use of the design model 630 may provide a predictive feature to the in situ defect analysis 610. In this regard, because the design model 630 may include information about the building of future layers of the part, certain characteristics of active layer dataset 615 may be analyzed in view of the future layers. In this manner, a current characteristic, such as a thermal characteristic of the active layer dataset, in combination with the design model 630, may reveal the existence of a defect or the ongoing development of a defect when a comparison with the signature library 620 is performed. As mentioned above, the defect signatures may also be developed based on design models. Therefore, the defect signatures may include information based on sensor data and the construction of a completed part that may have the same or similar architectures and features as the part currently be constructed and analyzed for defects. Accordingly, the inclusion of the design model 630 in the in situ defect analysis 610 may also facilitate the detection of defects in the part being manufactured. Additionally, regardless of the variety of inputs that may be utilized to facilitate in situ defect analysis 610, similarity thresholds with the defect signatures may be employed to determine that a defect has been identified. As such, a perfect match with a signature need not be necessary and therefore the high likelihood of a match with a defect signature may be sufficient to result in a defect detection at 640. According to some example embodiments, the similarity thresholds may be selected and controlled based on a desired degree of tolerance of a given part. As such, for example, the thresholds may be selected based on the requirements for certification of a part, if necessary.

Additionally, upon detection of a defect at 640, the process 600 may continue by formation of a defect model at 650. In this regard, the detection of a defect at 640 may result in the data associated with the defect being logged for use in generating or forming a defect model as a tomographic model of the part. Accordingly, a defect structure and morphology may be generated. Based on the raw melt data and possibly the signature used to detect the defect, a data representation of the defect may be determined and stored as a feature of a defect model. Each defect that is detected in the part may be added to the model and, as a result, a complete defect model of the part may be generated upon completion of the manufacturing of the part. The result may be, for example, an in situ thermally computed tomography of the part and may be embodied in a similar manner as an x-ray computed tomography of the part. As such, post-production analyses that would typically be performed on an x-ray computed tomography may be performed on the in situ generated tomography. More specifically, the defect model may be provided for part certification upon completion or immediately upon completion of manufacturing the part.

According to some example embodiments, upon detection of a defect at 640, an assessment of the defect may be performed to determine if the construction or building of the part should be discontinued at 650. In this regard, if a substantial defect is identified or a defect positioned at a location that can lead to a part failure, the build may be discontinued at 660. Upon discontinuing the build, a determination may be made to determine whether the defect is one that would require the part to be scrapped. Alternatively, at 670, a healing process may be performed to remedy the defect. In this regard, the process controller 352 may control the laser 302 to perform a scanning pass of the active layer of the part 310. Such a scanning pass may generate further raw melt data for analysis or the scanning pass may perform a healing of defects in the active layers or layers below the active layer. Alternatively, the laser may be controlled to melt material at a directed location on the active layer to cause heat to be conducted to a desired layer to resolve a defect in a healing pass on the active layer prior to proceeding to a subsequent layer.

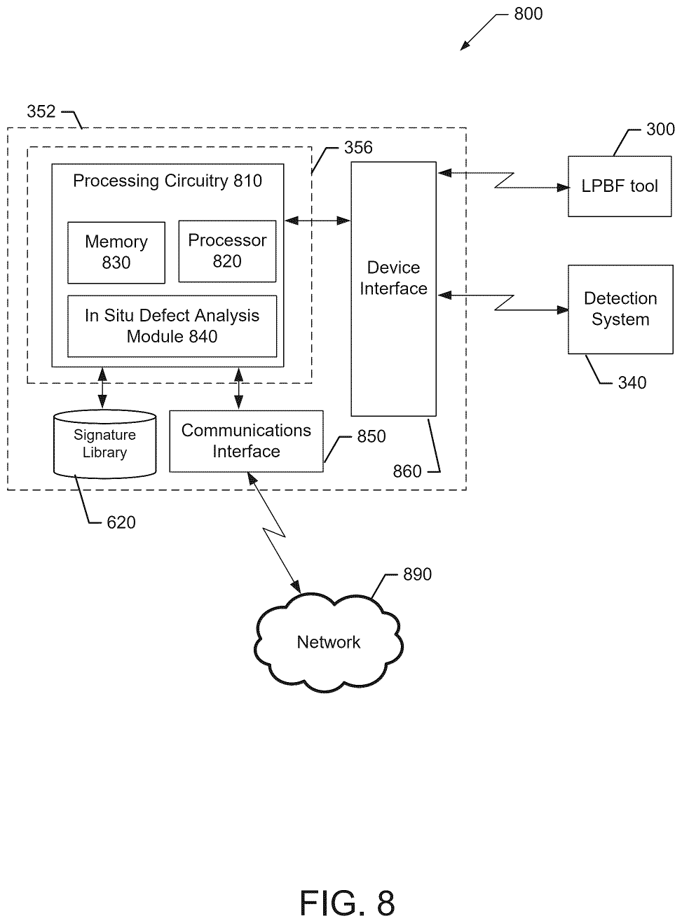

Now referring to FIG. 8, according to some example embodiments, an example apparatus 800 is provided that may monitor and analyze an additive manufacturing process. In this regard, the apparatus 800 may be embodied as or included in the process controller 352 of FIG. 3. The apparatus may include circuitry that may be centralized in a single device or distributed across a number of devices. As such, according to some example embodiments, the functionalities described with respect to the apparatus 800 may be performed by a centralized device or some functionalities may be performed by circuitry of another device. As such, the configuration of the apparatus 800 to perform the functionalities described herein may be performed by a number of distributed devices with circuitry to support to performance of the functionalities.

Therefore, according to some example embodiments, the apparatus 800 may include the FPGA 356 (which may itself include processing circuitry 810 that, in turn, includes a processor 820, a memory 830, the in situ defect analysis module 840, and a communications interface 850. Additionally, the apparatus 800 may include additional components not shown in FIG. 8 and the processing circuitry 810 may be operably coupled to other components of the apparatus 800 that are not shown in FIG. 8. Of note, the FPGA 356 is an example of an entity that performs calculations or mappings between input and output signals with the goal of optimizing the process conditions and/or reducing/healing defects. In principle, it could be electronic (e.g., a processor, integrated circuit, etc.) or optical, or some sort of hybrid (e.g., optoelectronic).

Further, according to some example embodiments, processing circuitry 810 may be in operative communication with or embody, the memory 830, the processor 820, in situ defect analysis module 840, and the communications interface 850. Through configuration and operation of the memory 830, the processor 820, the in situ defect analysis module 840, and the communications interface 850, the processing circuitry 810 may be configurable to perform various operations as described herein, including the operations and functionalities described with respect to the processes 600 and 700, as well as the process controller 352 described above. In this regard, the processing circuitry 810 may be configured to perform computational processing, memory management, and, additive manufacturing control and monitoring, according to various example embodiments. In some embodiments, the processing circuitry 810 may be embodied as a chip or chip set. In other words, the processing circuitry 810 may include one or more physical packages (e.g., chips) including materials, components or wires on a structural assembly (e.g., a baseboard). The processing circuitry 810 may be configured to receive inputs (e.g., via peripheral components), perform actions based on the inputs, and generate outputs (e.g., for provision to peripheral components). In an example embodiment, the processing circuitry 810 may include one or more instances of the processor 820, associated circuitry, and the memory 830. As such, the processing circuitry 810 may be embodied as a circuit chip (e.g., an integrated circuit chip, such as the field programmable gate array (FPGA 356)) configured (e.g., with hardware, software or a combination of hardware and software) to perform operations described herein.

In an example embodiment, the memory 830 may include one or more non-transitory memory devices such as, for example, volatile or non-volatile memory that may be either fixed or removable. The memory 830 may be configured to store information, data, applications, instructions or the like for enabling, for example, the functionalities described with respect to the in situ defect analysis module 840. The memory 830 may operate to buffer instructions and data during operation of the processing circuitry 810 to support higher-level functionalities, and may also be configured to store instructions for execution by the processing circuitry 810. The memory 830 may also store various information including the signature library 620. According to some example embodiments, the signature library 620 may be stored at remote location and accessed by the processing circuitry 810 via the communications interface 850. According to some example embodiments, various data stored in the memory 830 may be generated based on other received data (e.g., raw melt data from sensor 220, or the SATURN sensor of the detection system 340) and stored or the data may be retrieved via the communications interface 850 and stored in the memory 830.

As mentioned above, the processing circuitry 810 may be embodied in a number of different ways. For example, the processing circuitry 810 may be embodied as various processing means such as one or more processors that may be in the form of a microprocessor, graphics processing unit, or other processing element, a coprocessor, a controller, or various other computing or processing devices including integrated circuits such as, for example, an ASIC (application specific integrated circuit), an FPGA, or the like. In an example embodiment, the processing circuitry 810 may be configured to execute instructions stored in the memory 830 or otherwise accessible to the processing circuitry 810. As such, whether configured by hardware or by a combination of hardware and software, the processing circuitry 810 may represent an entity (e.g., physically embodied in circuitry—in the form of processing circuitry 810) capable of performing operations according to example embodiments while configured accordingly. Thus, for example, when the processing circuitry 810 is embodied as an ASIC, FPGA, or the like, the processing circuitry 810 may be specifically configured hardware for conducting the operations described herein. Alternatively, as another example, when the processing circuitry 810 is embodied as an executor of software instructions, the instructions may specifically configure the processing circuitry 810 to perform the operations described herein.

The communications interface 850 may include one or more interface mechanisms for enabling communication with other devices external to the apparatus 800, via, for example, network 890, which may, for example, be a local area network, the Internet, or the like, through a direct (wired or wireless) communication link to another external device, or the like. In some cases, the communications interface 850 may be any means such as a device or circuitry embodied in either hardware, or a combination of hardware and software that is configured to receive or transmit data from/to devices in communication with the processing circuitry 810. The communications interface 850 may be a wired or wireless interface and may support various communications protocols (WIFI®, BLUETOOTH®, cellular, or the like).

The device interface 860 may be input/output interface that operates between the processing circuitry 810 and peripheral devices that are controlled by and/or provide data to the processing circuitry 810. According to some example embodiments, the device interface 860 may be integrated into the processing circuitry 810 or the device interface 860 may be housed in a separate component configured to translate or otherwise interface with the peripheral devices in a manner that the processing circuitry 810 may not be able to directly. However, according to some example embodiments, the processing circuitry 810 may be configured to directly interface with peripheral devices.

In this regard, via the device interface 860, the processing circuitry 810 may be configured to interface with the laser 302 (or other energy source generator including one or more lasers) and the SATURN sensor of the detection system 340. In this regard, processing circuitry 810 may be configured to interface with the laser 302 to control operation of the laser 302 in the process of performing additive manufacturing as described herein. More specifically, the processing circuitry 810 may be configured to control the direction and intensity of the laser generated by the laser 302 (or other energy beam generated by an energy source generator). Further, the laser beam generated by the laser 302 may be a scanning laser, and therefore the processing circuitry 810 may be configured to control the scanning operations of the laser 302 for fusing additive media to perform a manufacturing operation or for performing a healing operation to remedy the occurrence of a detected defect in a part that is being manufactured in a healing pass that is performed on an active layer prior to moving on to a subsequent layer.

The in situ defect analysis module 840 may, according to some example embodiments, be circuitry that is part of or a configuration of the processor 820, possibly in combination with the memory 830. As such, the in situ defect analysis module 540 may be configured to cause the processing circuitry 810 to perform various functionalities as a component of the processing circuitry 810. As such, the in situ defect analysis module 840, and thus the processing circuitry 810, may be configured to control the laser 302 to cause a laser beam to heat a melt zone of the a part under construction to fuse an additive media (e.g., a metal powder) with an active layer of the part to build the part based on a part design model. In this regard, the part design model may have been provided to the processing circuitry 810 via the communications interface 850. The processing circuitry 810 may be configured to process the part design model, which may be a 3D digital model of the part, to prepare the part design model for use in manufacturing. According to some example embodiments, the part design model may be decomposed into a plurality of 2D layers that may be used for the layered manufacturing approach of some additive manufacturing techniques. The processing circuitry 810 may also be configured to interface with the SATURN sensor of the detection system 340 to capture raw melt data of the melt zone.

Since the SATURN sensor includes multiple channels, and in some cases, includes four or more independently filtered channels, which may or may not include at least one infrared and one visible light band, the dynamic laser material interactions that are observed provide highly accurate measurements of spectral response. The in situ defect analysis module 840, as component of the processing circuitry 810, may be configured to generate, based on the raw melt data, and particularly based on the four independently filtered channels of accurate data, an active layer dataset that is spatially defined, and analyze the active layer dataset with respect to a plurality of defect signatures within the defect library 360. In this regard, the defect library 360 may have been predefined based on a machine learning processing of historical sensor datasets with corresponding ground truth datasets. Additionally, the in situ defect analysis module 840 may be configured to detect a defect in the part based on the analysis of the active layer dataset with respect to a plurality of defect signatures. This detection of a defect may be performed simultaneously with the laser acting upon the active layer of the part for manufacturing of the part.

According to some example embodiments, the in situ defect analysis module 840 may be further configured to develop a defect model of the part based on the detection of the defect in combination with other defect detections identified in the part. Additionally, according to some example embodiments, the in situ defect analysis module 840 may be configured to provide, for example via the communications interface 850, the defect model for part certification upon completion of manufacturing of the part. Additionally, according to some example embodiments, the in situ defect analysis module 840 may be configured to develop a defect model of the part based on the active layer dataset and additional layer datasets corresponding to additional layers involved in manufacturing the part.

According to some example embodiments, the in situ defect analysis module 840 may be configured to discontinue construction of the part in response to detecting the defect. Further, according to some example embodiments, the in situ defect analysis module 840 may be configured to control the laser, via the laser 302, to perform a healing operation to remove the defect based on the analysis of the active layer dataset. The in situ defect analysis module 840 may also be configured to resume construction of the part in accordance with the part design model.

According to some example embodiments, the in situ defect analysis module 840 may also be configured to generate the active layer dataset to include temperature data that is spatially defined based on the spectral data or light intensity data provided by the SATURN sensor of FIG. 4. Additionally, according to some example embodiments, the in situ defect analysis module 840 may be configured to analyze the active layer dataset and previously constructed layer datasets for the part with respect to the plurality of defect signatures. In this regard, the in situ defect analysis module 840 may be further configured to detect the defect based on the analysis of the active layer dataset and previously constructed layer datasets with respect to the plurality of defect signatures.

As mentioned above, according to some example embodiments, the part design model may define a plurality of model layers including an active model layer that corresponds to the active layer and future model layers corresponding to future layers to be built in the construction of the part. In view of this, the in situ defect analysis module 840 may be configured to analyzing the active layer dataset and the future model layers with respect to the plurality of defect signatures, and detect the defect based on the analysis of the active layer dataset and the future model layers with respect to the plurality of defect signatures. Additionally, according to some example embodiments, the processing circuitry 810 may be configured to control the SATURN sensor to capture raw melt data of the melt zone.

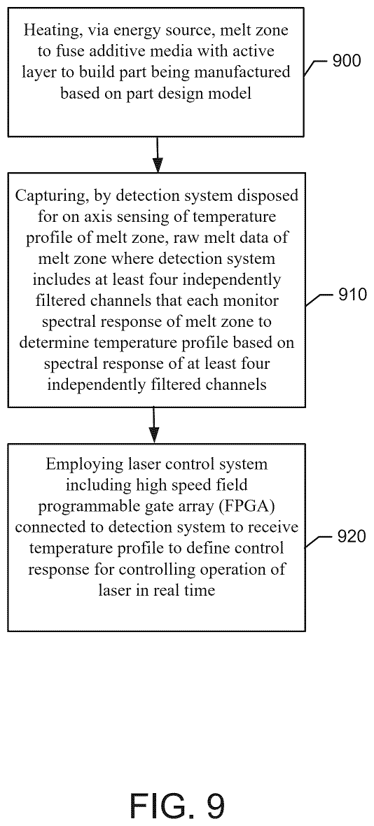

Now referring to FIG. 9, an example method for monitoring and analyzing an additive manufacturing process is provided. According to some example embodiments, the example method may include heating, via an energy source, a melt zone to fuse an additive media with an active layer to build a part being manufactured based on a part design model at operation 900. The method also includes capturing, by a detection system disposed for on axis sensing of a temperature profile of the melt zone, raw melt data of the melt zone at operation 910. The detection system includes a plurality of (e.g., in some cases at least four) independently filtered channels that each monitor a spectral response of the melt zone to determine the temperature profile based on the spectral response of the plurality of independently filtered channels. The method also includes employing a laser control system including a high speed field programmable gate array (FPGA) operably coupled to the detection system to receive the temperature profile to define a control response for controlling operation of the laser in real-time at operation 920. In some embodiments, the method (and a corresponding system capable of executing the method) may include (or be configured to perform) additional components/modules, optional operations, and/or the components/operations described above may be modified or augmented. Some examples of modifications, optional operations and augmentations are described below. It should be appreciated that the modifications, optional operations and augmentations may each be added alone, or they may be added cumulatively in any desirable combination. In this regard, for example, capturing, by the detection system, may include operably coupling the laser to the detection system to generate the four independently filtered channels via employing a dichroic beam splitter to generate a first intermediate beam and a second intermediate beam, employing a first optical beam splitter to split the first intermediate beam into a first beam and a second beam, and employing a second optical beam splitter to split the second intermediate beam into a third beam and a fourth beam. In an example embodiment, the method may further include employing a first optical bandpass filter to filter the first beam prior to digitization of the filtered first beam into a first filtered channel of the four independently filtered channels, employing a second optical bandpass filter to filter the second beam prior to digitization of the filtered second beam into a second filtered channel of the four independently filtered channels, employing a third optical bandpass filter to filter the third beam prior to digitization of the filtered third beam into a third filtered channel of the four independently filtered channels, and employing a fourth optical bandpass filter to filter the fourth beam prior to digitization of the filtered fourth beam into a fourth filtered channel of the four independently filtered channels. In some cases, the method may further include fiber coupling the laser to the detection system and arranging the detection system to be effectively on-axis with the laser. In an example embodiment, the four independently filtered channels may include at least one channel corresponding to a beam in a visible light band and at least another beam in an infrared band. In some cases, the method may further include controlling the laser via the laser control system to define a first pass operation for a current layer, the first pass operation being evaluated by the detection system for defect identification, and defining a healing pass operation for the current layer to heal at least one defect identified during the defect identification. In this regard, for example, the healing pass operation may sometimes be completed for the current layer prior to commencing a subsequent first pass operation for a subsequent layer. In an example embodiment, the high speed FPGA may define the control response within a response time of less than about 1 microsecond meaning that a delay of the system is less than 1 microsecond, and a calibration transfer function may be applied to measured optical data used to generate the temperature profile. In some cases, the laser control system may include a trained artificial intelligence model for identifying defects in a given layer based on the temperature profile, and the laser control system may define the control response to cure an identified defect based on further instruction from the trained artificial intelligence model. In an example embodiment, identifying defects may be performed responsive to analyzing a current layer dataset with respect to a plurality of defect signatures within a defect signature library, where the defect signature library is predefined based on a machine learning processing of historical sensor datasets with corresponding ground truth datasets.

Many modifications and other embodiments of the measuring device set forth herein will come to mind to one skilled in the art to which these inventions pertain having the benefit of the teachings presented in the foregoing descriptions and the associated drawings. Therefore, it is to be understood that the measuring devices are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits, or solutions described herein should not be thought of as being critical, required, or essential to all embodiments or to that which is claimed herein. Although specific terms are employed herein, they are used in a generic and descriptive sense only and not for purposes of limitation.

What is claimed is:

1. A system for controlling an additive manufacturing processing, the system comprising:
an energy source operable to emit a beam to heat a powder bed to form a melt pool;
a detection system disposed for on axis sensing of a temperature profile of the melt pool, the detection system comprising a plurality of independently filtered channels that each monitor a spectral response of the melt pool to determine the temperature profile based on the spectral response of the plurality of independently filtered channels; and
a control system comprising a high speed field programmable gate array (FPGA) or application-specific integrated circuit (ASIC) operably coupled to the detection system to receive the temperature profile and define a control response for controlling operation of the energy source.

2. The system of claim 1, wherein the detection system is operably coupled to the energy source to generate four or more independently filtered channels via:
an intermediate beam splitter that generates a first intermediate beam and a second intermediate beam;
a first optical beam splitter splitting the first intermediate beam into a first beam and a second beam; and
a second optical beam splitter splitting the second intermediate beam into a third beam and a fourth beam.

3. The system of claim 2, wherein the detection system further includes:
a first optical bandpass filter to filter the first beam prior to digitization of the filtered first beam into a first filtered channel of the four or more independently filtered channels;
a second optical bandpass filter to filter the second beam prior to digitization of the filtered second beam into a second filtered channel of the four or more independently filtered channels;
a third optical bandpass filter to filter the third beam prior to digitization of the filtered third beam into a third filtered channel of the four or more independently filtered channels; and
a fourth optical bandpass filter to filter the fourth beam prior to digitization of the filtered fourth beam into a fourth filtered channel of the four or more independently filtered channels.

4. The system of claim 2, wherein the energy source is fiber coupled to the detection system, and
wherein the detection system is on-axis with the energy source.

5. The system of claim 2, wherein the four or more independently filtered channels include at least one channel corresponding to a beam in a visible light band and at least another beam in an infrared band.

6. The system of claim 1, wherein the energy source is operable under control of the control system to define a first pass operation for a current layer, the first pass operation being evaluated by the detection system for defect identification, and
wherein the energy source is operable under control of the control system to define a healing pass operation for the current layer to heal at least one defect identified during the defect identification.

7. The system of claim 6, wherein the healing pass operation is completed for the current layer prior to commencing a subsequent first pass operation for a subsequent layer.

8. The system of claim 6, wherein the high speed FPGA defines the control response within a response time of less than about 1 to 10 microseconds, and
wherein a calibration transfer function is applied to measured optical data used to generate the temperature profile.

9. The system of claim 1, wherein the control system includes a trained artificial intelligence model for identifying defects in a given layer based on the temperature profile, and wherein the control system defines the control response to cure an identified defect based on further instruction from the trained artificial intelligence model.

10. The system of claim 9, wherein identifying defects is performed responsive to analyzing a current layer dataset with respect to a plurality of defect signatures within a defect signature library, the defect signature library being predefined based on a machine learning processing of historical sensor datasets with corresponding ground truth datasets.

11. A method for controlling an additive manufacturing process, the method comprising:
heating, via an energy source, a melt zone to fuse an additive media with an active layer to build a part being manufactured based on a part design model;
capturing, by a detection system disposed for on axis sensing of a temperature profile of the melt zone, raw melt data of the melt zone, the detection system comprising a plurality of independently filtered channels that each monitor a spectral response of the melt zone to determine the temperature profile based on the spectral response of four independently filtered channels of the plurality of independently filtered channels; and
employing a control system comprising a high speed field programmable gate array (FPGA) or application-specific integrated circuit (ASIC) operably coupled to the detection system to receive the temperature profile to define a control response for controlling operation of the energy source in real-time.

12. The method of claim 11, wherein capturing, by the detection system, comprises operably coupling the energy source to the detection system to generate four or more independently filtered channels via:
employing an intermediate beam splitter to generate a first intermediate beam and a second intermediate beam;
employing a first optical beam splitter to split the first intermediate beam into a first beam and a second beam; and
employing a second optical beam splitter to split the second intermediate beam into a third beam and a fourth beam.

13. The method of claim 12, further comprising:
employing a first optical bandpass filter to filter the first beam prior to digitization of the filtered first beam into a first filtered channel of the four or more independently filtered channels;
employing a second optical bandpass filter to filter the second beam prior to digitization of the filtered second beam into a second filtered channel of the four or more independently filtered channels;
employing a third optical bandpass filter to filter the third beam prior to digitization of the filtered third beam into a third filtered channel of the four or more independently filtered channels; and
employing a fourth optical bandpass filter to filter the fourth beam prior to digitization of the filtered fourth beam into a fourth filtered channel of the four or more independently filtered channels.

14. The method of claim 12, further comprising fiber coupling the energy source to the detection system, wherein the detection system is on-axis with the energy source.

15. The method of claim 12, wherein the four or more independently filtered channels include at least one channel corresponding to a beam in a visible light band and at least another beam in an infrared band.

16. The method of claim 11, further comprising controlling the energy source via the control system to define a first pass operation for a current layer, the first pass operation being evaluated by the detection system for defect identification, and
defining a healing pass operation for the current layer to heal at least one defect identified during the defect identification.

17. The method of claim 16, wherein the healing pass operation is completed for the current layer prior to commencing a subsequent first pass operation for a subsequent layer.

18. The method of claim 16, wherein the high speed FPGA defines the control response within a response time of less than about 1 to 10 microseconds, and
wherein a calibration transfer function is applied to measured optical data used to generate the temperature profile.

19. The method of claim 11, wherein the control system includes a trained artificial intelligence model for identifying defects in a given layer based on the temperature profile, and wherein the control system defines the control response to cure an identified defect based on further instruction from the trained artificial intelligence model.

20. The method of claim 19, wherein identifying defects is performed responsive to analyzing a current layer dataset with respect to a plurality of defect signatures within a defect signature library, the defect signature library being predefined based on a machine learning processing of historical sensor datasets with corresponding ground truth datasets.
